(19) United States
(12) Patent Application Publication
(10) Pub. No.: US 2015/0170223 A1
(43) Pub. Date: Jun. 18, 2015

(54) SYSTEM AND METHOD FOR CREATING PROMOTION CONTENT AND DISTRIBUTION THEREOF

(71) Applicant: Tena R. Clark, Pasadena, CA (US)

(72) Inventor: Tena R. Clark, Pasadena, CA (US)

(21) Appl. No.: 14/511,232

(22) Filed: Oct. 10, 2014

Related U.S. Application Data
(60) Provisional application No. 61/889,139, filed on Oct. 10, 2013.

(51) Int. Cl. G06Q 30/02; G06Q 50/00; G06Q 10/10

(52) U.S. Cl. CPC G06Q 30/0276; G06Q 30/0248; G06Q 10/107; G06Q 50/01

(57) ABSTRACT

A method and system for creating promotion content, the method comprising providing a user interface to a client device for creating an advertising campaign including promotions, receiving one or more parameters for a promotion associated with the advertising campaign, retrieving one or more media content from media content databases based on the parameters, generating promotion content based on the one or more parameters, the promotion content including a media content engine operable for playback of the one or more media content, and distributing a message to one or more messaging systems, the message facilitating access to the promotion content.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### CROSS REFERENCE TO RELATED APPLICATION

This application claims the priority of U.S. Provisional Application No. 61/889,139, entitled “SYSTEM AND METHOD FOR CREATING PROMOTION CONTENT AND DISTRIBUTION THEREOF,” filed on Oct. 10, 2013, the disclosure of which is hereby incorporated by reference in its entirety.

### BACKGROUND OF THE INVENTION

1. Field of the Invention

The invention described herein generally relates to electronic marketing, and in particular, an advertising system that uses media content as an enticement to get consumers to open and click through on marketing messages.

2. Description of the Related Art

The rapid increase in the number of users of electronic mail (commonly referred to as “email”) and the low cost of distributing electronic messages has made mass marketing via email messages an attractive advertising medium. Email messaging offers a powerful and cost-effective way to market products or services and build relationships with customers and prospects. Email is capable of reaching a wider audience in a shorter time period than needed to invest in a comparable direct marketing campaign. Due to the ease and cost of sending email to a very large number of recipients, the number of mass mailings for unsolicited email messages advertising has risen dramatically. Consequently, email messages are now frequently used as the medium for widespread marketing broadcasts of unsolicited messages to email addresses, commonly known as spam mail. Spam, however, is a growing problem for consumers and companies. Spam can cause a variety of problems, including lost time and productivity, increased exposure to security breaches, and the delivery of unwanted and sometimes harmful content. Increased dislike of spam and the problems it may cause, decreased attention given to the contents of spam, and causes the attractiveness and effectiveness of this form of advertising to diminish.

Current email advertisement methods do not adequately provide value to the recipient. Marketing email typically consists of text, pictures, HTML, scripts, and the like, as well as links that can be clicked on by the email recipient and that lead to Internet URLs that themselves contain information and/or items for sale. There is thus a need for an advertising system that uses media content such as music to entice consumers to open and click through on marketing emails. In addition to higher open and click through rates on the emails, landing page on-page times are also increased as a result of the user consuming the media.

### SUMMARY OF THE INVENTION

The present invention provides a method and system for creating promotion content, the method comprising providing a user interface to a client device for creating an advertising campaign including promotions, receiving one or more parameters for a promotion associated with the advertising campaign, retrieving one or more media content from media content databases based on the parameters, generating promotion content based on the one or more parameters, the promotion content including a media content engine operable for playback of the one or more media content, and distributing a message to one or more messaging systems, the message facilitating access to the promotion content.

In at least one embodiment, the one or more parameters include a redemption code requirement for accessing the one or more media content.

According to another embodiment, the promotion content comprises a webpage.

In certain embodiments, the one or more messaging systems include an email distribution system.

In other embodiments, the one or more messaging systems may include a social media messaging system.

According to one or more embodiments, the one or more media content is at least one of audio and video content.

The system for creating promotion content comprises a processor and a memory having executable instructions stored thereon that when executed by the processor cause the processor to provide a user interface to a client device over a communications network for creating an advertising campaign including promotions, receive one or more parameters for a promotion associated with the advertising campaign from the client device, retrieve one or more media content from media content databases based on the parameters, generate promotion content based on the one or more parameters, the promotion content including a media content engine operable for playback of the one or more media content, and distribute a message to one or more messaging systems, the message facilitating access to the promotion content.

In at least one embodiment of the system, the one or more parameters include a redemption code requirement for accessing the one or more media content.

According to another embodiment of the system, the promotion content comprises a webpage.

In certain embodiments of the system, the one or more messaging systems include an email distribution system.

In other embodiments of the system, the one or more messaging systems may include a social media messaging system.

According to one or more embodiments of the system, the one or more media content is at least one of audio and video content.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a computing system according to an embodiment of the present invention;

FIG. 2 illustrates a flowchart of a method for creating promotion content according to an embodiment of the present invention;

FIG. 3 illustrates promotion content according to an embodiment of the present invention;

FIG. 4 illustrates promotion content according to another embodiment of the present invention;

FIG. 5 illustrates a flowchart of a method for creating redeemable promotion content according to an embodiment of the present invention; and

FIG. 6 illustrates redeemable promotion content according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

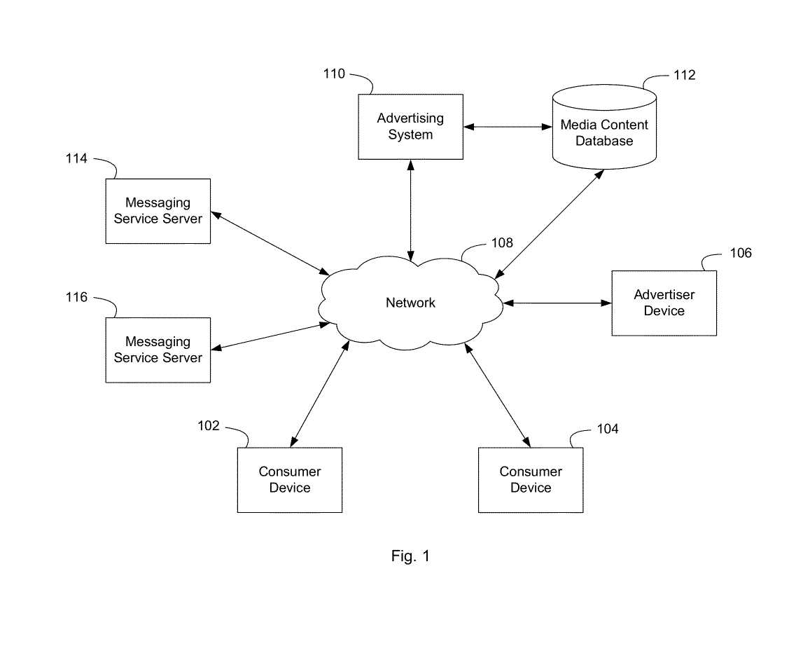

FIG. 1 illustrates a computing system according to an embodiment of the present invention. The system presented in FIG. 1 includes consumer device 102, consumer device 104, advertiser device 106, network 108, advertising system 110, media content database 112, messaging service server 114 and messaging service server 116. Consumer device 102, consumer device 104, and advertiser device 106 may comprise special purpose computing devices or client devices (e.g., personal computers, mobile devices, terminals, laptops, personal digital assistants (PDA), cell phones, tablet computers, e-book readers, or any computing device having a central processing unit and memory unit capable of connecting to a network). The devices of 102, 104 and 106 may also comprise a graphical user interface (GUI) or a browser application provided on a display (e.g., monitor screen, LCD or LED display, projector, etc.).

A client device may include or execute an application to communicate content, such as, for example, textual content, multimedia content, or the like. A client device may also include or execute an application to perform a variety of possible tasks, such as browsing, searching, playing various forms of content, including locally stored or streamed video, or games. The foregoing is provided to illustrate that claimed subject matter is intended to include a wide range of possible features or capabilities. A client device may also include or execute a variety of operating systems, including a personal computer operating system, such as a Windows, Mac OS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples.

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like. A social network may include individuals with similar experiences, opinions, education levels or backgrounds.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so called ‘virtual persons.’ An individual's social network may be represented in a variety of forms, such as visually, electronically or functionally. For example, a “social graph” or “socio-gram” may represent an entity in a social network as a node and a relationship as an edge or a link.

Network 108 may be any suitable type of network allowing transport of data communications across thereof. The network 108 may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. In one embodiment, the network may be the Internet, following known Internet protocols for data communication, or any other communication network, e.g., any local area network (LAN), or wide area network (WAN) connection, wire-line type connections, wireless type connections, or any combination thereof. Communications and content stored and/or transmitted may be encrypted using the Advanced Encryption Standard (AES) with a 256-bit key size, or any other encryption standard known in the art.

Advertising system 110 comprises one or more server devices. Servers, as described herein, may vary widely in configuration or capabilities but are comprised of at least a special-purpose digital computing device including at least one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like. An advertiser, via advertiser device 106, may receive advertising services on advertising system 110. The services or offerings of advertising system 110 may be provided as a cloud service or as an online service. Advertiser device 106 may establish electronic communication with advertising system 110 by network 108. Advertising system 110 may maintain accounts for a plurality of advertisers where each advertiser may log in to their account using credentials (e.g., user ID and password).

According to embodiments of the present invention, advertising system 110 uses music as an enticement to get consumers to open and click through on marketing messages. In one embodiment, advertising system 110 includes a message generation system and a redemption code playback system. The message generation system allows an advertiser to create promotion content including media content that an advertiser may distribute to a plurality of consumers via messaging service server 114 and messaging service server 116. Media content may include music, video, images, etc. that may be accessed, activated, and/or opened on a web browser or media player operating on a client device. Messaging service server 114 and 116 may be, for example, email services, social media/networking messaging (e.g., Facebook and Twitter), content syndication (e.g., RSS feeds), SMS, MMS, and any other types of electronic messaging to a consumer. Advertising system 110 includes media content database 112 for storing the media content and access parameters associated with the media content, which are described in further detail below. Media content database 112 may be comprised of one or more databases and servers. According to another embodiment, media content database 112 may be hosted by a third party network that of which advertising system 110 may access.

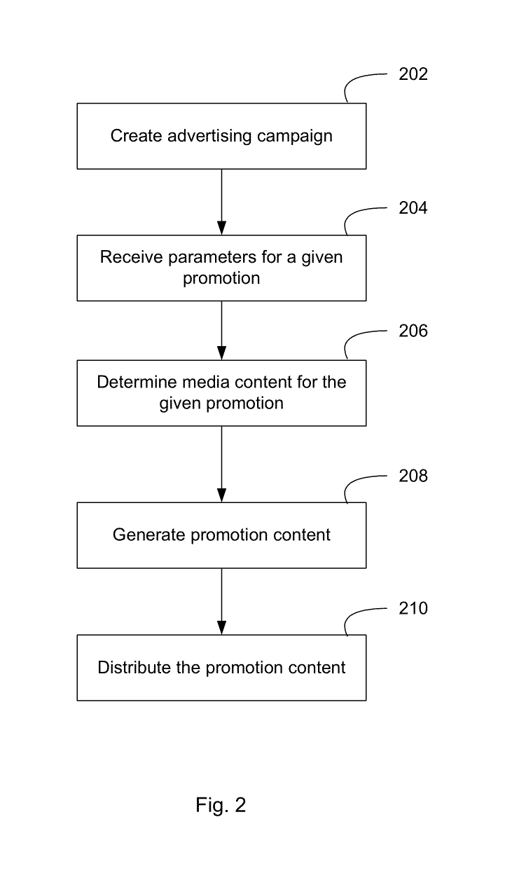

FIG. 2 presents a flowchart of a method for creating media content according to an embodiment of the present invention. An advertising campaign is created, step 202. A user may request, via a client device, to create the advertising campaign by interacting with an interface provided by an advertising system. The created advertising campaign may be associated with an account maintained on the advertising system. The user may provide contact information for the creator of the account, name of a company associated with the account, billing information, etc., to establish the account. Creating the advertising campaign may further include establishing a theme. Themes may be used to set a central message for individual advertisements and other forms of marketing communications used in promotional activities.

Parameters for a given promotion are received, step 204. An advertiser user may define and submit to the advertising system interface one or more parameters for promotions associated with the created advertising campaign. A promotion may include one or more advertisement messages that share a single idea and/or theme directed to a brand, service or product. The parameters received by the advertising system may include a selection of media channels (a specific medium in reaching the intended audience such as a particular messaging service), a theme (e.g., setting, subject, topic), brands, services or products being promoted, target audience (e.g., geography and demographics), and a duration or period of the given promotion.

Media content is determined for the given promotion, step 206. One or more media content may be automatically selected by the advertising system based on, for example, the theme selected in the received parameters to connect with the specified brand/product and targeted audience. The advertising system may maintain a predefined list of media content for a plurality of themes. In one embodiment, the advertising system may provide a list of recommended media content candidates that the advertiser may select for the promotion based on the received parameters for the given promotion. According to another embodiment, the advertiser user may further customize the promotion by providing the advertiser's own media content to the advertising system. Determining the media content may further include identifying and retrieving the media content from one or more media content databases and readying the media content for the promotion content.

The media content and parameters of the given promotion are used to generate promotion content, step 208. Generating the promotion content may include creation of a web page/landing page by the advertising system and embedding the web page with one or more media content engines in the web page to play or render the media content determined for the given promotion. Media content engines include multimedia players, flash players, or any other content renderer. The media content engines may include buttons or links for downloading or streaming media content from content servers/databases for rendering or playback by a recipient of the promotion content. The landing page may include text, images, and links in addition to one or more embedded media content engines.

Once the promotion content is created, the promotion content is distributed to consumers, step 210. The advertising system may distribute the promotion content as messages to consumers via messaging system(s). That is, messages are transmitted to messaging systems over a communications network to consumer accounts or inboxes. The messages may include a link to facilitate access the web page comprising the promotion content. According to an alternative embodiment, the messages themselves may include the promotion content where media content may be downloaded or streamed (by the media content engine) from within the messaging system by a consumer without having to navigate to a landing page from a link. Messaging systems include electronic communication systems such as email (e.g., in the body of the email) or social media/networking messaging to targeted consumers such as in a “tweet” using Twitter, a Facebook page or a multimedia message on a social networking platform. Alternately, the advertiser can distribute the promotion content directly from their servers to the messaging systems.

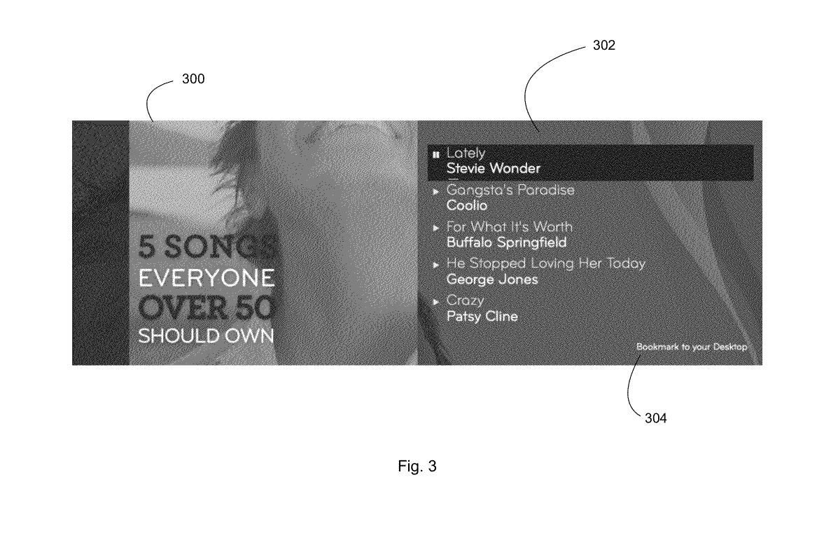

FIG. 3 presents promotion content according to an embodiment of the present invention. Promotion content 300, as illustrated, includes artwork and an embedded music player. A list of playable songs 302 is provided where each of the songs may be played and paused on promotion content 300. Promotion content 300 also includes bookmark to your desktop 304 feature, allowing a consumer to save the promotion content to their computer “desktop” for subsequent retrieval.

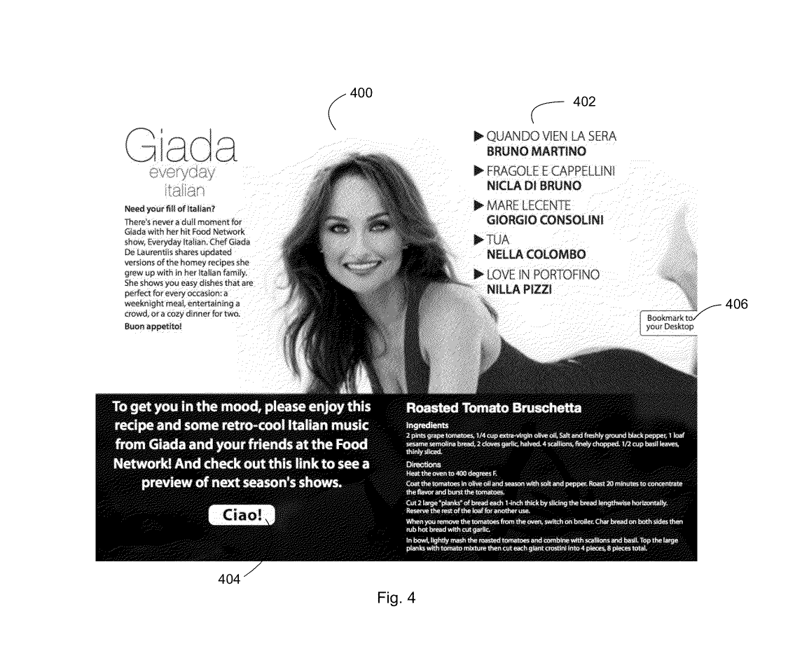

FIG. 4 presents promotion content according to another embodiment of the present invention. In the illustrated promotion content 400, parameters including an Italian theme promoting “Food Network” show, “Everyday Italian” may be selected by an advertiser. Media content selected for promotion content 400 includes background artwork and text, and a list of playable songs 402. Promotion content 400 includes hyperlink 404 that directs consumers to, for example, The Food Network's website. Bookmark to your desktop 406 allows a consumer to save the promotion content to their computer “desktop” for subsequent retrieval or playback.

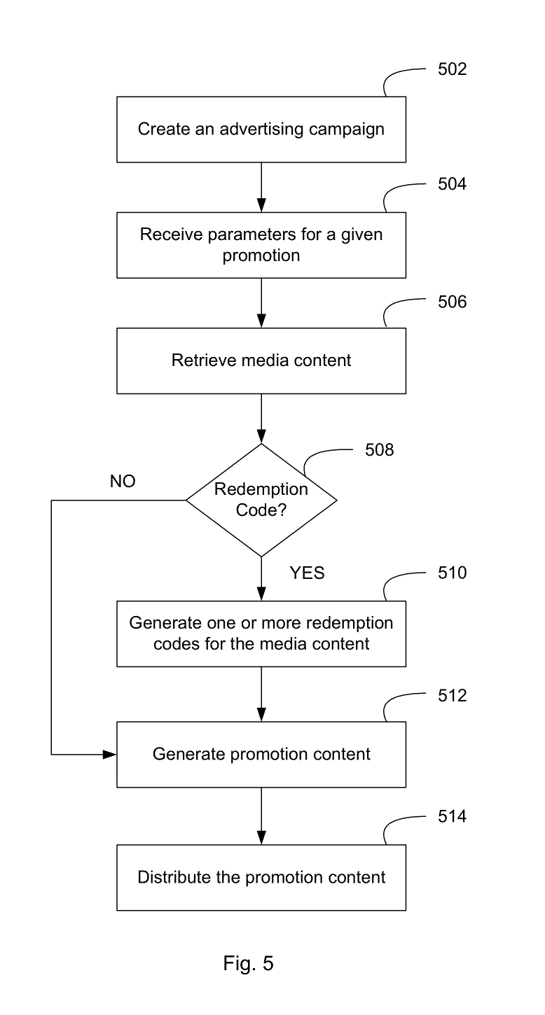

FIG. 5 presents a flowchart of a method for creating redeemable promotion content according to an embodiment of the present invention. An advertising campaign is created, step 502. The advertising campaign may include an account with a plurality of messages, content, and promotions directed to a brand, service or product. Parameters for a given promotion are received, step 504. The parameters may include a selection of media content to be used, the dates the media content can be redeemed, the dates the media content can be played (which may be longer than the redemption dates), whether the media content can be downloaded or only streamed, how many times the media content can be accessed over the time period, whether the consumer can share the media content with friends, whether the campaign requires a unique redemption code for each consumer, or if a single redemption code can be used a limited number of times (e.g., for multicast messaging such as Twitter or print advertising), a landing page URL to use for the campaign, and should the media content start playing automatically when the consumer arrives on the landing page.

Media content is retrieved, step 506. The media content may be retrieved based on the received parameters. According to one embodiment, the media content may be retrieved from databases and/or servers of one or more content providers such as music label companies, entertainment companies or content distributors. An advertiser creating the promotion content may specify in the received parameters whether a redemption code should be required to access, redeem, or unlock the media content. If a redemption code is determined as a required parameter, step 508, the method proceeds to step 510 where one or more redemption codes are generated for the media content. A set of unique redemption codes may be generated, and those redemption codes can be given to consumers by integration into their messaging system(s) (e.g., delivered in a message), delivered in a physical media, provided by a third party partner such as a retailer, or found in another form of electronic media such as on a social media web page. Otherwise, if redemption codes are not required, the method skips to step 512 to generate promotion content.

Generating the promotion content, step 512, may include creating a web page/landing page and embedding a media content engine in the page to play or render the retrieved media content. According to an alternative embodiment, instructions, script or code to download, stream or play the media content may embedded into the media content engine. Media content engines include multimedia players, flash players, or any other content renderer. Activation of the media content engines by the end user causes playback of the retrieved media content. The landing page may include text, images, and links in addition to one or more embedded media content engines.

The promotion content is distributed to consumers, step 514. Promotion content may be distributed in the form of a message or communication including a link to the landing page. The message may be electronically distributed from an advertising system server to one or more messaging service servers. The message is received by the consumer recipients via their messaging service and the consumer may click on the link in the message to access to the landing page and redeem codes (if required) to utilize the media content engine. The redemption codes may be provided either in the message or in a separate message. Redemption of the codes can happen in one of two ways—either by the consumer clicking on a unique link in an electronic message, or via the consumer coming to an advertising website and entering a redemption code. When the consumer attempts to redeem a redemption code, the valid dates and usage counts for the code are checked in order to make sure it is valid.

Once the redemption code is confirmed, the consumer may be assigned a unique session ID and a cookie may be placed on their device. The unique session ID can be used for tracking usage, as well as determining when the consumer returns to the page so that the usage count for the redemption code is not duplicated. Once the redemption code has been validated, the consumer may be directed to, provided with, or shown the landing page specified by the campaign, and they can begin listening to their music or access the media content embedded within the promotion content.

The advertising system may also include a reporting system that allows detailed analysis of all the interactions that have taken place, as a whole, for each promotion and for each campaign. All interactions by the consumer may be tracked so they can be reported to the advertiser. This includes tracking the starting and stopping/skipping of the media content, tracking how many redemptions codes were claimed, how many tracks were listened to, how long consumers stayed on the page, as well as clicking through to any links that may be placed on the landing page, etc.

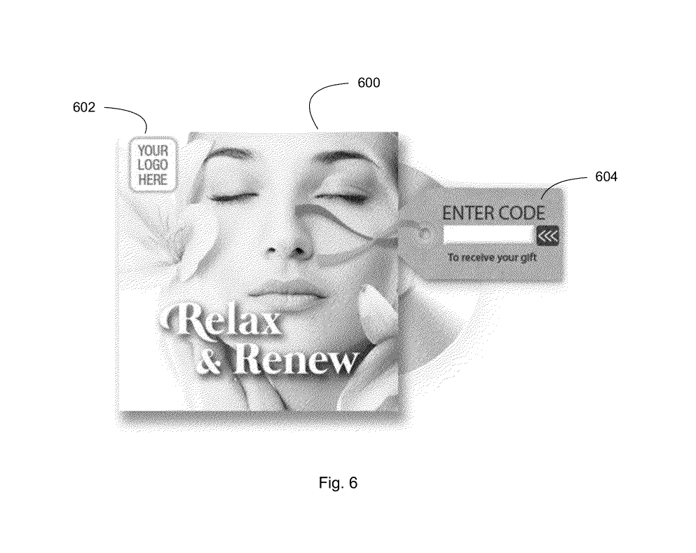

FIG. 6 presents redeemable promotion content according to an embodiment of the present invention. Promotion content 600 includes a text field 604 for inputting a promotion code to access media content. According to one embodiment, promotion content 600 may be a template provided by the advertising system for use by any advertiser. The template may include a predetermined theme, media content, artwork, text, etc., and the advertiser may simply only need to place their logo in logo box 602 to create promotion content for distribution.

FIGS. 1 through 6 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for creating promotion content, the method comprising:
providing, via a processing device over a communications network, a user interface to a client device for creating an advertising campaign including promotions;
receiving, via the processing device, one or more parameters for a promotion associated with the advertising campaign from the client device;
retrieving, via the processing device, one or more media content from media content databases based on the parameters;
generating, via the processing device, promotion content based on the one or more parameters, the promotion content including a media content engine operable for playback of the one or more media content; and
distributing, via the processing device, a message to one or more messaging systems over the communications network, the message facilitating access to the promotion content.

2. The method of claim 1 wherein the one or more parameters include a redemption code requirement for accessing the one or more media content.

3. The method of claim 1 wherein the promotion content comprises a webpage.

4. The method of claim 1 wherein the one or more messaging systems include an email distribution system.

5. The method of claim 1 wherein the one or more messaging systems include a social media messaging system.

6. The method of claim 1 wherein the one or more media content is at least one of audio and video content.

7. A system for creating promotion content, the system comprising:
a processor; and
a memory having executable instructions stored thereon that when executed by the processor cause the processor to:
provide a user interface to a client device over a communications network for creating an advertising campaign including promotions;
receive one or more parameters for a promotion associated with the advertising campaign from the client device;
retrieve one or more media content from media content databases based on the parameters;
generate promotion content based on the one or more parameters, the promotion content including a media content engine operable for playback of the one or more media content; and
distribute a message to one or more messaging systems over the communications network, the message facilitating access to the promotion content.

8. The system of claim 7 wherein the one or more parameters include a redemption code requirement for accessing the one or more media content.

9. The system of claim 7 wherein the promotion content comprises a webpage.

10. The system of claim 7 wherein the one or more messaging systems include an email distribution system.

11. The system of claim 7 wherein the one or more messaging systems include a social media messaging system.

12. The system of claim 7 wherein the one or more media content is at least one of audio and video content.
